(19) United States
(12) Patent Application Publication
(10) Pub. No.: US 2019/0223216 A1
(43) Pub. Date: Jul. 18, 2019

(54) SYSTEMS AND METHODS FOR CONTROLLING UE INTER-FREQUENCY MEASUREMENTS IN GAPS IN PRESENCE OF LBT

(71) Applicant: TELEFONAKTIEBOLAGET L M ERICSSON (PUBL), Stockholm (SE)

(72) Inventor: Iana Siomina, TÄBY (SE)

(21) Appl. No.: 16/304,632

(22) PCT Filed: May 26, 2017
(86) PCT No.: PCT/IB2017/053126

§ 371 Date: Nov. 26, 2018

Related U.S. Application Data
(60) Provisional application No. 62/342,062, filed on May 26, 2016.

(51) Int. Cl. H04W 74/08; H04W 24/10; H04W 72/04; H04W 76/28; H04W 48/16; H04L 1/00

(52) U.S. Cl. CPC H04W 74/0808; H04W 24/10; H04L 1/0026; H04W 76/28; H04W 48/16; H04W 72/0453

(57) ABSTRACT

Embodiments of the present disclosure relate to determining a measurement time period for performing an inter-frequency measurement within gaps either on a carrier frequency subject to Listen-Before-Talk (LBT) or while using measurement gaps that are shared with another carrier(s). In some embodiments, a method of operation of a User Equipment (UE) comprises configuring measurement gaps for performing at least one first inter-frequency measurement on a first carrier frequency subject to LBT, determining a measurement time period T1 for performing the at least one first inter-frequency measurement in the measurement gaps, and performing the at least one first inter-frequency measurement based on the measurement time period T1. In this manner, UE behavior in the presence of LBT and measurement gaps is well-defined.

### RELATED APPLICATIONS

This application claims the benefit of provisional patent application Ser. No. 62/342,062, filed May 26, 2016, the disclosure of which is hereby incorporated herein by reference in its entirety.

### TECHNICAL FIELD

License Assisted Access (LAA), inter-frequency measurements, Listen-Before-Talk (LBT), measurement gaps.

### BACKGROUND

Inter-Frequency Measurements and Measurement Gaps

Inter-frequency measurements in Third Generation Partnership Project (3GPP) Long Term Evolution (LTE) are conducted during periodic inter-frequency measurement gaps which are configured in such a way that each gap starts at a System Frame Number (SFN) and subframe meeting the following conditions:

SFN mod T=FLOOR(gapOffset/10);

subframe=gapOffset mod 10;

with T=MGRP/10, where MGRP stands for “measurement gap repetition period.” Evolved Universal Terrestrial Radio Access Network (E-UTRAN) must provide a single measurement gap pattern with constant gap duration for concurrent monitoring of all frequency layers and Radio Access Technologies (RATs). Two configurations are supported by the User Equipment device (UE), with MGRP of 40 and 80 milliseconds (ms), both with the measurement gap length of 6 ms. In practice, due to the switching time, this leaves less than six but at least five full subframes for measurements within each such measurement gap.

In LTE, measurement gaps are configured by the network to enable measurements on the other LTE frequencies and/or other RATs. The gap configuration is signalled to the UE over Radio Resource Control (RRC) protocol as part of the measurement configuration. The gaps are common (i.e., shared by) for all frequencies, but the UE can measure only one frequency at a time within each gap.

License Assisted Access (LAA), Unlicensed Spectrum, and Frame Structure Type 3

(FS3)

LAA, or operation based on FS3 (the FS3 is specified in 3GPP Technical Specification (TS) 36.211), which was introduced in LTE Release (Rel) 13, refers to the UE operation on at least one carrier in unlicensed spectrum such as Band 46 also used for WiFi access, e.g., a UE can be configured with Carrier Aggregation (CA) with a Primary Cell (PCell) in Band 1 (licensed spectrum) and a Secondary Cell (SCell) in Band 46 (unlicensed spectrum). An enhanced or evolved Node B (eNB) operating in the unlicensed band only transmits signals which may be used for UE measurements using so called Discovery Reference Symbols (DRSs). Unlike Rel-8 Common Reference Symbols (CRSs), DRS is not transmitted in every subframe and is instead transmitted periodically (e.g., every 160 ms). Moreover, the eNB may perform so called Listen-Before-Talk (LBT) procedures to check that no other node (such as another eNB or a WiFi access point) is transmitting in the unlicensed spectrum before it transmits DRS. This means that from a UE perspective, the eNB may be unable to transmit any particular DRS transmission. In certain regions, LBT functionality is required from a regulatory point of view to ensure fair coexistence of different radios and access technologies on the unlicensed band.

In Rel-14, in addition to the Downlink (DL) operation in the unlicensed spectrum as described above, Uplink (UL) operation is also being introduced. This means that a UE may be configured with UL transmissions on one or more SCells in the unlicensed spectrum and perform UL LBT if needed.

LBT

According to the LBT procedure, the transmitter in unlicensed spectrum (e.g., the eNB in case of DL or the UE in case of UL) needs to listen on the carrier before it starts to transmit. If the medium is free, the transmitter can transmit (referred sometimes as LBT being successful), while if the medium is busy, e.g. some other node is transmitting, the transmitter cannot transmit (referred sometimes as LBT being unsuccessful or fails) and the transmitter can try again at a later time. Therefore, the LBT procedure enables a Clear Channel Assessment (CCA) check before using the channel. Based on the CCA, if the channel is found to be clear, then the LBT is considered to be successful. But if the channel is found to be occupied, then the LBT is considered to be failure (also known as LBT failure). The LBT failure requires the network node not to transmit signals in the same and/or subsequent subframes. Exact subframes and also the number of subframes where transmission is forbidden depends on the specific design of the LBT scheme.

Due to LBT a transmission in an unlicensed band may be delayed until the medium becomes free again. In case there is no coordination between the transmitting nodes (which often is the case), the delay may appear random.

In the simplest form, LBT is performed periodically with a period equal to certain units of time; as an example one unit of time duration, i.e. 1 Transmission Time Interval (TTI), 1 time slot, 1 subframe, etc. The duration of listening in LBT is typically in the order of few to tens of microseconds (ps). Typically, for LBT purposes, each LTE subframe is divided in two parts: in the first part, the listening takes place and the second part carries data if the channel is seen to be free. The listening occurs at the beginning of the current subframe and determines whether or not data transmission will continue in this subframe and a few next subframes. Hence, the data transmission in a subframe P until subframe P+n is determined by the outcome of listening during the beginning of subframe P. The number n depends on system design and/or regulatory requirements.

Measurements in Unlicensed Spectrum Under FS3

Currently, under FS3, the UE may perform CRS-based measurements and Channel State Information Reference Signal (CSI-RS) based measurements. Only intra-frequency requirements have so far been completed, while inter-frequency measurement requirements are still under discussion.

Distributed Antenna Systems (DASs)

Typically a DAS is a network where multiple spatially separated antenna nodes can be connected to a common source. A DAS may be deployed indoors or outdoors. Herein, a DAS may be any system using, e.g., Remote Radio Heads (RRHs), Remote Radio Units (RRUs), even small base stations, or more generally any Transmission Points (TPs) connected to a common source, etc. The common source may be, e.g., a base station. Herein, a DAS is understood in a broad sense so that a shared cell deployment (where multiple TPs belong to the same shared cell) or Coordinated Multi-Point (CoMP) deployment are also considered special cases of DAS. In one further example, a common source can be used for multiple TPs deployed indoors and provide radio signal transmissions for a big multi-floor building where each floor can be served by one or more of such TPs.

Shared Cell Deployments

A shared cell is a type of DL CoMP where multiple geographically separated TPs dynamically coordinate their transmission towards the UE. The unique feature of a shared cell is that all TPs within the shared cell have the same Physical Cell Identifier (PCI). This means that the UE cannot distinguish between the TPs by the virtue of the PCI decoding. The PCI is acquired during a measurement procedure, e.g. cell identification, etc. A TP may comprise one or more antenna ports. The TP can be uniquely identified by a unique identifier aka a TP Identifier (ID).

The shared cell approach can be implemented by distributing the same cell specific signals on all points (within the macro point coverage area). With such a strategy, the same physical signals such as Primary Synchronization Signals (PSSs), Secondary Synchronization Signals (SSSs), Cell Specific Reference Signals (CRSs), Positioning Reference Signals (PRSs), etc. and the same physical channels such as the Physical Broadcast Channel (PBCH), the Physical Downlink Shared Channel (PDSCH) containing paging and System Information Blocks (SIBs), control channels (Physical Downlink Control Channel (PDCCH), Physical Control Format Indicator Channel (PCFICH), Physical Hybrid Automatic Repeat Request (HARQ) Indicator Channel (PHICH)), etc. are transmitted from each TP in the DL. Tight synchronization in terms of transmission timings between the TPs within a shared cell is used, e.g., in order of ±100 nanoseconds (ns) between any pair of nodes.

This enables the physical signals and channels transmitted from M points to be combined over air. The combining is similar to what is encountered in single-frequency networks for broadcast.

Each TP may also be configured to transmit CSI-RS signals which are unique to each TP. Therefore, the CSI-RS enables the UE to uniquely identify a TP within a shared cell. The UE may also use the CSI-RS for performing measurement (e.g., CSI Reference Signal Received Power (RSRP)) which in turn enables the UE to determine the strongest TP within a shared cell.

### SUMMARY

Embodiments of the present disclosure relate to determining a measurement time period for performing an inter-frequency measurement within gaps either on a carrier frequency subject to Listen-Before-Talk (LBT) or while using measurement gaps that are shared with another carrier(s). In some embodiments, a method of operation of a User Equipment device (UE) comprise configuring measurement gaps for performing at least one first inter-frequency measurement on a first carrier frequency subject to LBT, determining a measurement time period T1 for performing the at least one first inter-frequency measurement in the measurement gaps, and performing the at least one first inter-frequency measurement based on the measurement time period T1. In this manner, UE behavior in the presence of LBT and measurement gaps is well defined. Further, the measurement time period T1 can be determined to account for LBT and, in some embodiments, the measurement procedure can be adapted in the presence of LBT to meet a measurement requirement(s).

In some embodiments, the method further comprises sending a result of the at least one first inter-frequency measurement to another node.

In some embodiments, determining the measurement time period T1 comprises determining the measurement time period T1 based on a predefined rule, a set of predefined values, a table of predefined values, a message received from another node, and/or at least one LBT-related configuration or LBT-related data.

In some embodiments, determining the measurement time period T1 comprises determining the measurement time period T1 such that the measurement time period T1 is a function of a number of transmission occasions which could be used for measurement by the UE but which are not available at the UE due to LBT on the first carrier frequency.

In some embodiments, determining the measurement time period T1 comprises determining the measurement time period T1 such that the measurement time period T1 is a function of a number of cells that are competing for a channel on the first carrier frequency to measure.

In some embodiments, determining the measurement time period T1 comprises determining the measurement time period T1 such that the measurement time period T1 is a function of a parameter reflecting a competition level for accessing a channel on the first carrier frequency and/or a channel of another carrier frequency. In some embodiments, the parameter is cell-specific. In some other embodiments, the parameter is carrier specific. In some embodiments, the parameter is a scaling factor which increases the measurement time period T1 when accessing the channel is difficult or a probability of accessing the channel is below a threshold. In some embodiments, the parameter is related to LBT success rate or probability or LBT failure rate or probability. In some embodiments, the parameter is determined by the UE. In some embodiments, the parameter is signaled to the UE from a network node.

In some embodiments, determining the measurement time period T1 comprises determining the measurement time period T1 as

T1=(M1*N_{freq}+L1*N)*Max {T_{DMTC}_{_{periodicity}}, MGRP}

where:

M1 is a parameter determining a basic measurement time period on the first carrier frequency without LBT, even though f1 is subject to LBT,

N_{freq} is a total number of carrier frequencies configured in the UE,

L1 is a number of transmission occasions which could be used for UE measurements on the first carrier frequency but which are not available at the UE due to LBT,

N is a number of the total number of carrier frequencies configured in the UE that are subject to LBT,

T_{DMTC}_{_{periodicity}} is a discovery signal measurement timing configuration periodicity of higher layer, N_{freq}, and

MGRP is a measurement gap repetition period.

In some embodiments, determining the measurement time period T1 comprises determining the measurement time period T1 as

T1=(M1*N_{freq}+L1*N)*Max {T_{DMTC}_{_{periodicity}}MGRP, DRXcycleLength}

where:

M1 is a parameter determining a basic measurement time period on the first carrier frequency without LBT, even though f1 is subject to LBT,

N_{freq} is a total number of carrier frequencies configured in the UE,

L1 is a number of transmission occasions which could be used for UE measurements on the first carrier frequency but which are not available at the UE due to LBT,

N is a number of the total number of carrier frequencies configured in the UE that are subject to LBT,

T_{DMTC}_{_{periodicity}} is a discovery signal measurement timing configuration periodicity of higher layer, N_{freq},

MGRP is a measurement gap repetition period, and

DRXcycleLength is a Discontinuous Reception (DRX) cycle length when DRX is configured for the UE.

In some embodiments, determining the measurement time period T1 comprises determining the measurement time period T1 as

T1=(M1*n*N_{freq})*Max {T_{DMTC}_{_{periodicity}}, MGRP}

where:

M1 is a parameter determining a basic measurement time period on the first carrier frequency without LBT, even though f1 is subject to LBT,

n is a number of cells on the first carrier frequency that are measured, the number of cells on the first carrier frequency that are measured and are competing for the channel, a maximum per-carrier number of competing measured cells among a number of measured carrier frequencies, or a parameter reflecting a competition level for a channel on the first carrier frequency to transmit in transmission occasions measured by the UE,

N_{freq} is a total number of carrier frequencies configured in the UE,

T_{DMTC}_{_{periodicity}} is a discovery signal measurement timing configuration periodicity of higher layer, N_{freq}, and

MGRP is a measurement gap repetition period.

In some embodiments, the measurement time period T1 is a function of a number of carriers subject to LBT for which the UE is configured to perform measurements.

In some embodiments, the measurement time period T1 is a function of a number of carriers sharing the measurement gaps.

In some embodiments, the measurement time period T1 is a function of a parameter that determines a basic measurement time period on the first carrier frequency without LBT failure.

In some embodiments, the measurement time period T1 is a function of a number of competing for the channel cells to measure on the first carrier frequency.

In some embodiments, the method further comprises controlling sharing of the measurement gaps between the at least one first inter-frequency measurement on the first carrier frequency and at least one other inter-frequency measurement on at least one other carrier. Further, in some embodiments, the at least one other carrier comprises at least one other carrier subject to LBT. In some embodiments, the at least one other carrier comprises at least one other carrier not subject to LBT. In some embodiments, the method further comprises determining a measurement time period T2 for performing at least one second inter-frequency measurement on a second carrier frequency that is not subject to LBT but shares the measurement gaps with the first carrier frequency. In some embodiments, the method further comprises performing the at least one second inter-frequency measurement based on the measurement time period T2. In some embodiments, the method further comprises sending the at least one second inter-frequency measurement to another node. In some embodiments, the method further comprises using the at least one second inter-frequency measurement for one or more operational tasks.

In some embodiments, the method further comprising sending the at least one first inter-frequency measurement to another node.

In some embodiments, the method further comprises using the at least one first inter-frequency measurement for one or more operational tasks.

Embodiments of a UE are also disclosed. In some embodiments, a UE is adapted to configure measurement gaps for performing at least one first inter-frequency measurement on a first carrier frequency subject to LBT, determine a measurement time period T1 for performing the at least one first inter-frequency measurement in the measurement gaps, and perform the at least one first inter-frequency measurement based on the measurement time period T1. In some embodiments, the UE is further adapted to perform the method of operation of a UE according to any one of the embodiments disclosed herein.

In some embodiments, a UE comprises at least one transceiver, at least one processor, and memory storing instructions executable by the at least one processor whereby the UE is operable to configure measurement gaps for performing at least one first inter-frequency measurement on a first carrier frequency subject to LBT, determine a measurement time period T1 for performing the at least one first inter-frequency measurement in the measurement gaps, and perform the at least one first inter-frequency measurement based on the measurement time period T1.

In some embodiments, a UE comprises a measurement gap module operable to configure measurement gaps for performing at least one first inter-frequency measurement on a first carrier frequency subject to LBT, a measurement time determining module operable to determine a measurement time period T1 for performing the at least one first inter-frequency measurement in the measurement gaps, and a measurement performing module operable to perform the at least one first inter-frequency measurement based on the measurement time period T1.

Embodiments of a method of operation of a node in a cellular communications network are also disclosed. In some embodiments, a method of operation of a node comprises configuring measurement gaps for a UE to perform at least one first inter-frequency measurement on a first carrier subject to LBT, determining a measurement time period T1 for the UE for performing the at least one first inter-frequency measurement in the measurement gaps, and configuring in the UE the at least one first inter-frequency measurement on the first carrier based on the measurement time period T1.

In some embodiments, determining the measurement time period T1 comprises determining the measurement time period T1 based on a predefined rule, a set of predefined values, a table of predefined values, a message received from another node, and/or at least one LBT-related configuration or LBT-related data.

In some embodiments, determining the measurement time period T1 comprises determining the measurement time period T1 such that the measurement time period T1 is a function of a number of transmission occasions which could be used for measurement by the UE but which are not available at the UE due to LBT on the first carrier frequency.

In some embodiments, determining the measurement time period T1 comprises determining the measurement time period T1 such that the measurement time period T1 is a function of a number of cells that are competing for a channel on the first carrier frequency to measure.

In some embodiments, determining the measurement time period T1 comprises determining the measurement time period T1 such that the measurement time period T1 is a function of a parameter reflecting a competition level for accessing a channel on the first carrier frequency and/or a channel of another carrier frequency. In some embodiments, the parameter is cell-specific. In some other embodiments, the parameter is carrier specific. In some embodiments, the parameter is a scaling factor which increases the measurement time period T1 when accessing the channel is difficult or a probability of accessing the channel is below a threshold. In some embodiments, the parameter is related to LBT success rate or probability or LBT failure rate or probability.

In some embodiments, determining the measurement time period T1 comprises determining the measurement time period T1 as

T1=(M1*N_{freq}+L1*N)* Max{T_{DMTC}_{_{periodicity}}, MGRP}

where:

M1 is a parameter determining a basic measurement time period on the first carrier frequency without LBT, even though f1 is subject to LBT,

N_{freq} is a total number of carrier frequencies configured in the UE,

L1 is a number of transmission occasions which could be used for UE measurements on the first carrier frequency but which are not available at the UE due to LBT,

N is a number of the total number of carrier frequencies configured in the UE that are subject to LBT,

T_{DMTC}_{_{periodicity}} is a discovery signal measurement timing configuration periodicity of higher layer, N_{freq}, and

MGRP is a measurement gap repetition period.

In some embodiments, determining the measurement time period T1 comprises determining the measurement time period T1 as

T1=(M1*N_{freq}+L1*N)*Max{T_{DMTC}_{_{periodicity}}, MGRP, DRXcycleLength}

where:

M1 is a parameter determining a basic measurement time period on the first carrier frequency without LBT, even though f1 is subject to LBT,

N_{freq} is a total number of carrier frequencies configured in the UE,

L1 is a number of transmission occasions which could be used for UE measurements on the first carrier frequency but which are not available at the UE due to LBT,

N is a number of the total number of carrier frequencies configured in the UE that are subject to LBT,

T_{DMTC}_{_{periodicity}} is a discovery signal measurement timing configuration periodicity of higher layer, N_{freq},

MGRP is a measurement gap repetition period, and

DRXcycleLength is a DRX cycle length when DRX is configured for the UE.

In some embodiments, determining the measurement time period T1 comprises determining the measurement time period T1 as

T1=(M1*n*N_{freq})*Max {T_{DMTC}_{_{periodicity}}, MGRP}

where:

M1 is a parameter determining a basic measurement time period on the first carrier frequency without LBT, even though f1 is subject to LBT,

n is a number of cells on the first carrier frequency that are measured, the number of cells on the first carrier frequency that are measured and are competing for the channel, a maximum per-carrier number of competing measured cells among a number of measured carrier frequencies, or a parameter reflecting a competition level for a channel on the first carrier frequency to transmit in transmission occasions measured by the UE,

N_{freq} is a total number of carrier frequencies configured in the UE,

T_{DMTC}_{_{periodicity}} is a discovery signal measurement timing configuration periodicity of higher layer, N_{freq}, and

MGRP is a measurement gap repetition period.

In some embodiments, the measurement time period T1 is a function of a number of carriers subject to LBT for which the UE is configured to perform measurements.

In some embodiments, the measurement time period T1 is a function of a number of carriers sharing the measurement gaps.

In some embodiments, the measurement time period T1 is a function of a parameter that determines a basic measurement time period on the first carrier frequency without LBT failure.

In some embodiments, the measurement time period T1 is a function of a number of competing for the channel cells to measure on the first carrier frequency.

In some embodiments, the method further comprises controlling sharing of the measurement gaps at the UE between the at least one first inter-frequency measurement on the first carrier frequency and at least one other inter-frequency measurement on at least one other carrier. In some embodiments, the at least one other carrier comprises at least one other carrier subject to LBT. In some embodiments, the at least one other carrier comprises at least one other carrier not subject to LBT.

In some embodiments, the method further comprises receiving a measurement report from the UE based on the measurement time period T1.

In some embodiments, the method further comprises determining a measurement time period T2 for performing at least one second inter-frequency measurement on a second carrier frequency that is not subject to LBT but shares the measurement gaps with the first carrier frequency.

In some embodiments, the method further comprises configuring in the UE the at least one second inter-frequency measurement on the second carrier based on the measurement time period T2.

In some embodiments, the method further comprises receiving a measurement report from the UE based on the measurement time period T2.

In some embodiments, the method further comprises sending the at least one first inter-frequency measurement and/or the at least one second inter-frequency measurement contained in the respective measurement report to another node.

In some embodiments, the method further comprises using the at least one first inter-frequency measurement and/or the at least one second inter-frequency measurement contained in the respective measurement report for one or more operational tasks.

Embodiments of a node for a cellular communications network are also disclosed. In some embodiments, a node is adapted to configure measurement gaps for a UE to perform at least one first inter-frequency measurement on a first carrier subject to LBT, determine a measurement time period T1 for performing the at least one first inter-frequency measurement in the measurement gaps, and configure in the UE the at least one first inter-frequency measurement on the first carrier based on the measurement time period T1. In some embodiments, the node is further adapted to perform the method of operation of a node according to any one of the embodiments disclosed herein.

In some embodiments, a node comprises at least one processor and memory storing instructions executable by the at least one processor whereby the node is operable to configure measurement gaps for a UE to perform at least one first inter-frequency measurement on a first carrier subject to LBT, determine a measurement time period T1 for performing the at least one first inter-frequency measurement in the measurement gaps, and configure in the UE the at least one first inter-frequency measurement on the first carrier based on the measurement time period T1.

In some embodiments, a node comprises a measurement gap module operable to configure measurement gaps for a UE to perform at least one first inter-frequency measurement on a first carrier subject to LBT, a time period determining module operable to determine a measurement time period T1 for performing the at least one first inter-frequency measurement in the measurement gaps, and a configuring module operable to configure in the UE the at least one first inter-frequency measurement on the first carrier based on the measurement time period T1

Those skilled in the art will appreciate the scope of the present disclosure and realize additional aspects thereof after reading the following detailed description of the embodiments in association with the accompanying drawing figures.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a scenario in which a User Equipment device (UE) fails to perform inter-frequency measurement on a carrier frequency due to measurement gaps and downlink (DL) Listen-Before-Talk (LBT);

FIG. 2 illustrates one example of a cellular communications network in which embodiments of the present disclosure may be implemented;

FIG. 3 is a flow chart that illustrates a method of operation of a UE according to some embodiments of the present disclosure;

FIG. 4 is a flow chart that illustrates a method of operation of a network node according to some embodiments of the present disclosure;

FIGS. 5 to 7 are block diagrams of a network node according to some embodiments of the present disclosure; and

FIGS. 8 and 9 are block diagrams of a UE according to some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

Any two or more embodiments described in this document may be combined in any way with each other. Furthermore, even though the examples herein are given in the License Assisted Access (LAA) context, the embodiments described herein are not limited to LAA. The described embodiments are not limited to Long Term Evolution (LTE), but can also be adapted in other Radio Access Technologies (RATs), e.g., Universal Terrestrial Radio Access (UTRA), LTE-Advanced, Fifth Generation (5G), NX (which is also referred to as New Radio (NR)), Narrowband Internet of Things (NB-IoT), WiFi, Bluetooth, etc.

In some embodiments, a non-limiting term “User Equipment device (UE)” is used. As used herein, a “UE” can be any type of wireless device capable of communicating with a network node or another UE over radio signals. The UE may also be a radio communication device, a target device, a Device to Device (D2D) UE, a machine type UE or a UE capable of Machine to Machine (M2M) communication, a sensor equipped with a UE, an iPad, a tablet, mobile terminals, a smart phone, Laptop Embedded Equipment (LEE), Laptop Mounted Equipment (LME), Universal Serial Bus (USB) dongles, Customer Premises Equipment (CPE), etc.

Also, in some embodiments, generic terminology “network node” is used. A “network node” can be any kind of network node which may comprise a radio network node such as a base station, a radio base station, a base transceiver station, a base station controller, a network controller, an enhanced or evolved Node B (eNB), a Node B, a Multi-Cell/Multicast Coordination Entity (MCE), a relay node, an access point, a radio access point, a Remote Radio Unit (RRU), a Remote Radio Head (RRH), a core network node (e.g., a Mobility Management Entity (MME), a Self Organizing Network (SON) node, a coordinating node, a positioning node (e.g., Serving Mobile Location Centre (SMLC), an Evolved SMLC (E-SMLC), etc.), a Minimization of Drive Tests (MDT) node, etc.), or even an external node (e.g., a third party node, a node external to the current network), etc.

The term “radio node” used herein may be used to denote a UE or a radio network node.

The term “signaling” used herein may comprise any of: high-layer signaling (e.g., via Radio Resource Control (RRC)), lower-layer signaling (e.g., via a physical control channel or a broadcast channel), or a combination thereof. The signaling may be implicit or explicit. The signaling may further be unicast, multicast, or broadcast. The signaling may also be directly to another node or via a third node.

The term Discovery Reference Symbol (DRS) or discover (or discovery) signal may comprise of any type of reference signal, which can be used by the UE for performing one or more measurements. Examples of DRSs are Common Reference Symbol (CRS), Channel State Information Reference Signal (CSI-RS), Primary Synchronization Signal (PSS), Secondary Synchronization Signal (SSS), Multicast Broadcast Single Frequency Network (MBSFN) reference signal, etc. One or more DRSs may be transmitted in the same DRS time resource. Examples of

DRS time resource are symbol, subframe, slot, etc.

The term “measurement” herein refers to radio measurements. Some examples of the radio measurements are: DRS or discovery signal measurement, Received Signal Strength Indicator (RSSI) measurement, channel occupancy measurement, WiFi RSSI measurement, signal strength or signal power measurements (e.g., Reference Signal Received Power (RSRP) or Channel State Information (CSI) RSRP), signal quality measurements (e.g., Reference Signal Received Quality (RSRQ), Signal to Interference plus Noise Ratio (SINR)), timing measurements (e.g., UE Receive-Transmit (Rx-Tx) time difference, base station Rx-Tx time difference, timing advance, Reference Signal Time Difference (RSTD), Round Trip Time (RTT), Time of Arrival (TOA)), Radio Link Monitoring (RLM) measurements, CSI, Precoding Matrix Indicator (PMI), cell detection, cell identification, number of successful reports, number of Acknowledgements (ACKs)/Negative Acknowledgements (NACKs), failure rate, error rate, correct system information reading, etc. The measurements may be absolute or relative (e.g., absolute RSRP and relative RSRP). The measurements may be performed for one or more different purpose, e.g., Radio Resource Management (RRM), SON, positioning, MDT, etc. The measurements may be, e.g., intra-frequency measurements, inter-frequency measurements, or Carrier Aggregation (CA) measurements. The measurements may be performed in the licensed and/or unlicensed spectrum. The measurements or measurement reporting may be single measurements, periodic or aperiodic, event-triggered, logged measurements, etc. The measurements may be unidirectional, e.g., downlink (DL) measurement or uplink (UL) measurements, or bidirectional, e.g., Rx-Tx or RTT.

The term “radio signal” used herein may refer, e.g., to one or more of: reference signal (e.g., CRS, CSI-RS, MBSFN Reference Signal (RS), Positioning Reference Signal (PRS), cell-specific reference signal, UE-specific reference signal), synchronization signal (e.g., PSS, SSS, etc.), radio channel (e.g., control channel, broadcast or multicast channel, etc.), discovery or DRS signal, etc.

The term Listen-Before-Talk (LBT) used herein may correspond to any type of Carrier Sense Multiple Access (CSMA) procedure or mechanism which is performed by the node on a carrier before deciding to transmit signals on that carrier. CSMA or LBT may also be interchangeably called Clear Channel Assessment (CCA), clear channel determination, etc.

The term time resource used herein may correspond to any type of physical resource or radio resource expressed in terms of length of time. Examples of time resources are: symbol, time slot, subframe, radio frame, Transmission Time Interval (TTI), interleaving time, etc.

At least the following problems may be envisioned with the existing solutions:

Measurement gaps are configured for all inter-frequency carriers but only one carrier can be measured at a time by the UE; however, the carrier selected by the UE may be impacted by DL LBT while the other carriers may not. In this case, the probability of UE measurement failure increases if the inter-frequency cell selected for measurements within a gap happens to be not available for measurements due to DL LBT (which may be not known to the UE in advance).

UE behavior is unclear with respect to carrier selection for measurements within a gap when at least one carrier is subject to LBT.

How to define UE measurement time period is unclear when an inter-frequency carrier is subject to LBT.

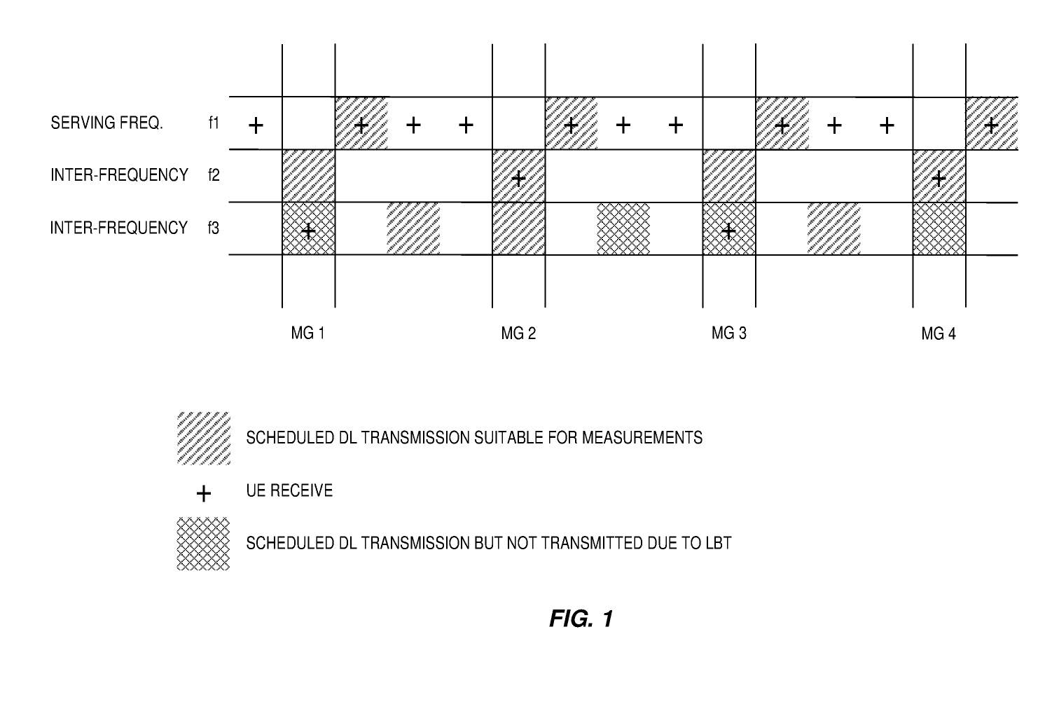

FIG. 1 illustrates one serving carrier frequency and two inter-frequencies. A UE is performing measurements on the serving cell on f1 without gaps and two inter-frequency neighbor cells on f2 and f3 in measurement gaps shared by f2 and f3. The UE selects to measure f3 in measurement gaps 1 and 3, and measure f2 in measurement gaps 2 and 4, and the serving cell can be measured outside measurement gaps. However, f3 is subject to DL LBT and the neighbor cell on f3 was not able to access the channel for four of its transmissions, three of which fall in the UE measurement gaps and two of which the UE intended to measure but then detected LBT instead. So, out of two transmissions which the UE could measure, both were not transmitted due to DL LBT, and the measurement on f3 failed. If the UE would measure f3 instead of f2 in the measurement gap 2, the UE measurement could be successful. Yet another potential problem is that the UE may be measuring multiple cells on the same carrier frequency within the same gap and some of the cells may not access the channel while other cells may be able to grabs the channel, e.g., in measurement gap 1 there may be one cell on f3 which could not transmit but there could be another cell, also to be measured by the UE, which has access to the channel.

Embodiments of the present disclosure relate to determining a measurement time period for performing an inter-frequency measurement within gaps either on a carrier frequency subject to LBT or while using measurement gaps that are shared with another carrier(s). The measurement time period accounts for the LBT impact and for the gap sharing impact. In some embodiments, the impact of channel sharing by multiple cells on a carrier (intra- or inter-frequency) is also modeled in the measurement time period. The embodiments are further extended for Distributed Antenna System (DAS) and shared cell deployments.

At least the following embodiments are described in this document.

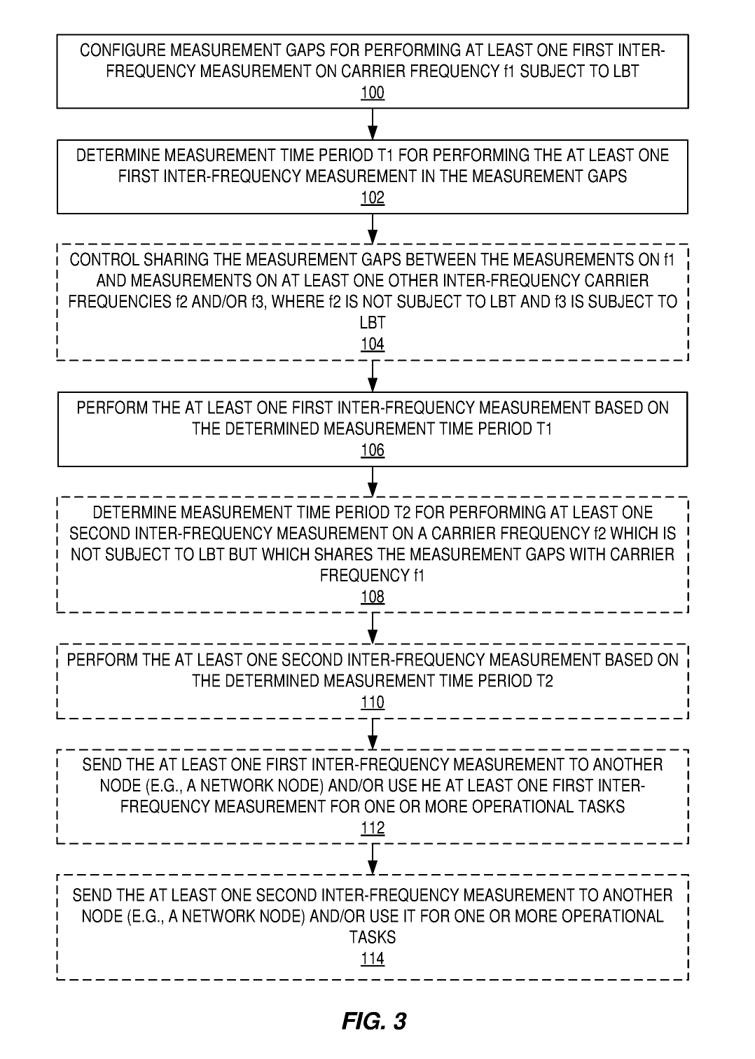

Methods in a UE for performing inter-frequency measurements on a carrier frequency f1, comprising the steps of (see FIG. 3):

Step 100: Configuring measurement gaps for performing at least one first inter-frequency measurement on a carrier frequency f1 subject to LBT

Step 102: Determining a measurement time period T1 for performing the at least one first inter-frequency measurement in the measurement gaps

Step 104 (optional): Controlling sharing the measurement gaps between the measurements on f1 and measurements on at least one of the other inter-frequency carrier frequencies f2 and/or f3, where f2 is not subject to LBT and f3 is subject to LBT

Step 106: Performing the at least one first inter-frequency measurement based on the determined measurement time period T1

Step 108 (optional): Determining a measurement time period T2 for performing at least one second inter-frequency measurement on a carrier frequency f2 which is not subject to LBT but which shares the measurement gaps with carrier frequency f1

Step 110 (optional): Performing the at least one second inter-frequency measurement based on the determined measurement time period T2

Step 112 (optional): Sending the at least one first inter-frequency measurement to another node (e.g., a network node) and/or using it for one or more operational tasks

Step 114 (optional): Sending the at least one second inter-frequency measurement to another node (e.g., a network node) and/or using it for one or more operational tasks

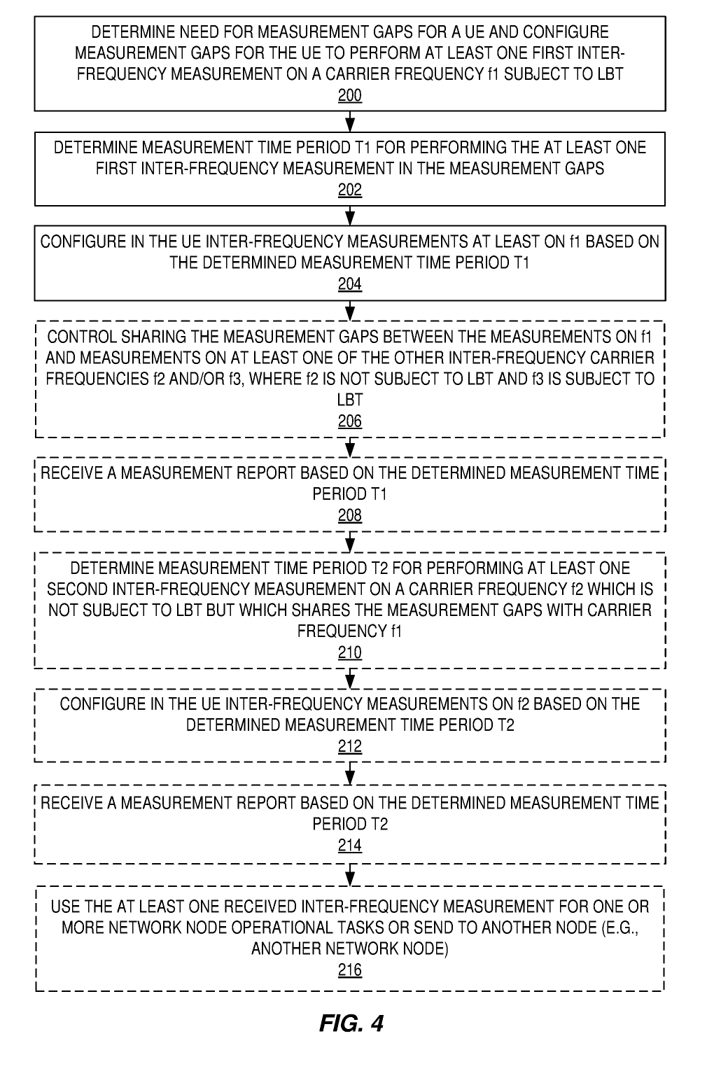

Methods in a network node for controlling UE inter-frequency measurements on a carrier frequency f1, comprising the steps of (see FIG. 4):

Step 200: Determining the need for measurement gaps for a UE (e.g., based on UE capability to perform inter-frequency measurements with or without gaps) and configuring measurement gaps for a UE to perform at least one first inter-frequency measurement on a carrier frequency f1 subject to LBT

Step 202: Determining a measurement time period T1 for performing the at least one first inter-frequency measurement in the measurement gaps

Step 204: Configuring in the UE inter-frequency measurements at least on f1 based on the determined measurement time period T1

Step 206 (optional): Controlling (e.g., by means of measurement configuration and/or transmission configuration and/or cell list) sharing the measurement gaps between the measurements on f1 and measurements on at least one of the other inter-frequency carrier frequencies f2 and/or f3, where f2 is not subject to LBT and f3 is subject to LBT

Step 208 (optional): Receiving a measurement report based on the determined measurement time period T1

Step 210 (optional): Determining a measurement time period T2 for performing at least one second inter-frequency measurement on a carrier frequency f2 which is not subject to LBT but which shares the measurement gaps with carrier frequency f1

Step 212 (optional): Configuring the UE inter-frequency measurements on f2 based on the determined measurement time period T2

Step 214 (optional): Receiving a measurement report based on the determined measurement time period T2

Step 216 (optional): Using the at least one received inter-frequency measurement for one or more network node operational tasks or sending to another node (e.g., another network node)

At least the following advantages can be envisioned with the described embodiments:

Well-defined UE behavior in presence of LBT and measurement gaps

Measurement time period is specified to account for LBT

Possibility to adapt inter-frequency measurement procedure in presence of LBT and meet a measurement requirement

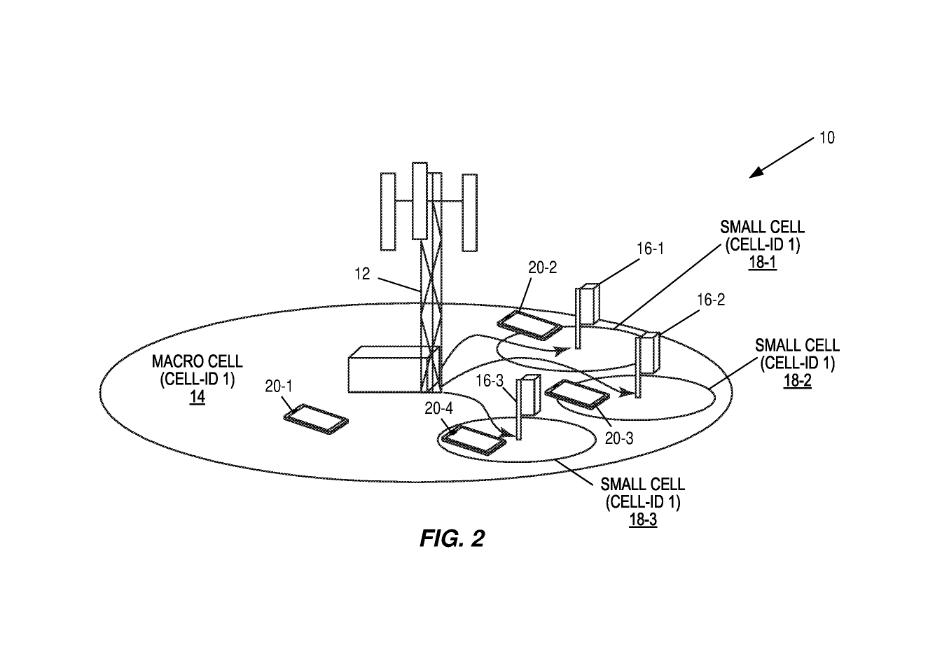

FIG. 2 illustrates one example of a cellular communications network 10 in which embodiments of the present disclosure may be implemented. Note that the cellular communications network 10 is only one example and is to be understood as being non-limiting. As illustrated, the cellular communications network 10 includes a macro node 12 (e.g., a base station such as, e.g., an eNB) serving a macro cell 14 and a number of RRHs 16-1 through 16-3 (generally referred to herein collectively as RRHs 16 and individually as RRH 16) serving respective small cells 18-1 through 18-3 (generally referred to herein collectively as small cells 18 and individually as small cell 18). The cellular communications network 10 is a shared cell deployment in which the macro cell 14 and the small cells 18 share the same cell Identity (ID) (e.g., the same Physical Cell ID (PCI)). The macro node 12 and the RRHs 16 provide radio access to a number of UEs 20-1 through 20-4 (generally referred to herein collectively as UEs 20 and individually as UE 20).

With respect to a UE 20, the cells 14 and 18 may be on a serving carrier (i.e., be serving cells of the UE 20) ora non-serving carrier (i.e., be non-serving cells of the UE 20). Examples of serving carriers are a Primary Component Carrier (PCC), also known as a Primary Cell (PCell), and a Secondary Component Carrier (SCC), also known as a Secondary Cell (SCell), in CA (aka multi-carrier), a Primary Secondary Component Carrier (PSCC), and a SCC in Dual Connectivity (DC). Examples of non-serving carriers are inter-frequency carriers, inter-RAT carriers, etc.

Note that measurements on non-serving carriers can be performed using measurement gaps or without measurement gaps.

Both the macro node 12 and the RRHs 16 are examples radio access nodes. One or more of these radio access nodes operate on a carrier(s) in an unlicensed frequency spectrum. As discussed herein, transmission on an unlicensed carrier may require LBT. Embodiments of the present disclosure relate to determining a measurement time period for performing an inter-frequency measurement within gaps either on a carrier frequency subject to LBT or while using measurement gaps that are shared with another carrier(s).

Note that while the example of FIG. 2 illustrates the macro cell 14 and the small cells 18-1 through 18-3 in a shared cell, heterogeneous deployment, the cellular communications network 10 includes many cells operating on different carrier frequencies in the unlicensed spectrum, which are subject to LBT. For example, the UE 20-1 may be within the macro cell 14 of the macro node 12 where the macro cell 14 is operating on a carrier frequency in an unlicensed spectrum. The UE 20-1 is configured to perform measurements on this carrier frequency. In addition, the UE 20-1 may be configured to perform inter-frequency measurements on one or more additional carrier frequencies, which may include one or more carrier frequencies in the unlicensed spectrum and, potentially, one or more carrier frequencies in a licensed spectrum. Systems and methods are disclosed herein that enable the UE 20-1 to perform inter-frequency measurements in such a scenario.

As illustrated in FIG. 3, methods in a UE 20 for performing inter-frequency measurements on a carrier frequency f1 comprise:

Step 100: Configuring measurement gaps for performing at least one first inter-frequency measurement on a carrier frequency f1 subject to LBT

Step 102: Determining a measurement time period T1 for performing the at least one first inter-frequency measurement in the measurement gaps

Step 104 (optional): Controlling sharing the measurement gaps between the measurements on f1 and measurements on at least one of the other inter-frequency carrier frequencies f2 and/or f3, where f2 is not subject to LBT and f3 is subject to LBT

Step 106: Performing the at least one first inter-frequency measurement based on the determined measurement time period T1

Step 108 (optional): Determining a measurement time period T2 for performing at least one second inter-frequency measurement on a carrier frequency f2 which is not subject to LBT but which shares the measurement gaps with carrier frequency f1

Step 110 (optional): Performing the at least one second inter-frequency measurement based on the determined measurement time period T2

Step 112 (optional): Sending the at least one first inter-frequency measurement to another node (e.g., a network node) and/or using it for one or more operational tasks

Step 114 (optional): Sending the at least one second inter-frequency measurement to another node (e.g., a network node) and/or using it for one or more operational tasks

An example scenario may be outlined as follows:

A UE 20, which needs measurement gaps to perform inter-frequency measurements, is configured to perform at least one first inter-frequency measurement on one or more cells on an inter-frequency carrier f1 which is subject to LBT,

The UE 20 may also be configured to perform at least one second inter-frequency measurement on one or more cells on an inter-frequency carrier f2 which is not subject to LBT,

The UE 20 may also be configured to perform at least one third inter-frequency measurement on one or more cells on an inter-frequency carrier f3 which is subject to LBT.

Performing a measurement in the above may also comprise meeting a predefined requirement related to the determined measurement time period. Hence, the UE 20 may need to adapt its measurement procedure in order to meet the requirement (e.g., measurement requirement, cell identification requirement, measurement accuracy requirement, etc.).

Note that while methods and processes are described herein as including a number of “steps,” the “steps” may be performed in any desired order unless otherwise stated or required.

Step 100: In this step, the UE 20 configures measurement gaps for performing at least one first inter-frequency measurement on a carrier frequency f1 subject to LBT.

The measurement gaps may comprise one or more of:

common gaps for all or a group of inter-frequencies,

carrier specific gaps,

autonomous gaps.

The measurement gap configuration may be determined by the UE 20 and/or a network node (e.g., a macro node 12).

In another embodiment, the measurement gaps may also be configured adaptively for at least one carrier to account for LBT. For example:

A UE 20 may select a specific type of measurement gaps or a specific measurement gap configuration, while accounting for LBT,

The UE 20 may configure per-carrier measurement gaps for carriers subject to LBT,

The UE 20 may configure more measurement gaps over a time period or a measurement pattern with a shorter periodicity (e.g., 40 milliseconds (ms) and not 80 ms) of measurement gaps if it is to be used for performing inter-frequency measurements on at least one carrier which is subject to LBT,

The UE 20 may adaptively configure the length of the measurement gaps to increase the probability of successful inter-frequency measurements,

Configure autonomous gaps, adaptively to the channel availability, for performing inter-frequency measurements on f1.

Step 102: The determined measurement time period depends on the measurement type (see above for measurement type examples) and the signals or channels to be measured, e.g., synchronization signals, cell-specific reference signals such as CRS, Transmission Point (TP) (e.g., RRH) specific reference signals such as CSI-RS, etc.

The determining of the measurement time period T1 may comprise, e.g., one or more of:

Determining based on a predefined rule,

Selecting T1 from a set of predefined values or from a table,

Determining based on a message, indication, or a value received from another node (e.g., a network node),

Determining based on history or stored information (e.g., configuration or statistics),

Determining based on LBT-related configuration or data (e.g., collected LBT statistics or at least one LBT-related configuration parameter),

Determining based on measurements,

Determining based on condition evaluation (e.g., with respect to a threshold).

The determined measurement time period T1 may have one or more of the following characteristics:

T1 is a function of the number N of carriers (possibly including serving) subject to LBT,

T1 is a function of the number K of inter-frequency carriers subject to LBT (K may be the same as or smaller than the total number of inter-frequency carriers),

T1 is a function of the number Q of carriers not subject to LBT (Q is smaller than the total number of carriers),

T1 is a function of the number R of carriers sharing the measurement gaps,

T1 is a function of one, some or all of L_i (i=1, 2, . . . ,N), where L_i is the number of transmission occasions which could be used for UE measurements on inter-frequency carrier f_i but which are not available at the UE 20 due to LBT (i.e., based on the channel assessment), and N is the total number of carrier frequencies (possibly including serving) which are configured for UE operation and which are subject to LBT, e.g.:

T1 is a function of L_1, where L_1 is the number of transmission occasions (e.g., discovery signal occasions) which could be used for UE measurements on inter-frequency carrier f1 but which are not available at the UE 20 due to LBT (i.e., based on the channel assessment),

T1 is a function of L_3 (see the example scenario above), where L_3 is the number of transmission occasions which could be used for UE measurements on inter-frequency carrier f3 but which are not available at the UE 20 due to LBT (i.e., based on the channel assessment),

T1 depends on a function of one, some, or all of L_i (i=1, 2, . . . , N), where the function may be, e.g., sum, maximum, minimum, average, Xth percentile, median, statistical expectation, a distribution function, etc.

T1 is a function of L_all, where L_all is the total number of transmission occasions over all carriers subject to LBT which are not available due to LBT (i.e., based on channel assessments of individual respective carriers),

T1 is a function of L_interAll, where L_interAll is the total number of transmission occasions over all inter-frequency carriers subject to LBT which are not available due LBT (i.e., based on channel assessments of individual respective carriers),

T1 is a function of one, some, or all M_i (i=1, 2, . . . , N), where M_i is a parameter determining the basic measurement time period on f_i without LBT, even though f_i is subject to LBT

T1 is a function of M_1, where M_1 is a parameter determining the basic measurement time period on f1 without LBT (e.g., M_1=6 in 6*Max{T_DMTC_periodicity,MGRP}*N_freq), even though f1 is subject to LBT

T1 is a function of M_3, where M_3 is a parameter determining the basic measurement time period on f3 without LBT, even though f3 is subject to LBT

T1 is depends on a function of one, some, or all of M_i (i=1, 2, . . . , N), where M_i is a parameter determining the basic measurement time period on f_i without LBT, even though f_i is subject to LBT, and where the function may be, e.g., sum, maximum, minimum, average, Xth percentile, median, statistical expectation, a distribution function, etc.

T1 is a function of one, some, or all M_k (k=1, 2, . . . , Q), where M_k is a parameter determining the measurement time period on f_k which is not subject to LBT, and where Q is the number of carriers not subject to LBT

T1 is a function of M_2, where M_2 is a parameter determining the measurement time period on f2 not subject to LBT

T1 is a function of a number of competing for the channel cells to measure on the same carrier, e.g., on f1 and/or on f3 where LBT is performed, or

T1 is a function of a parameter reflecting a competition level for accessing the channel on f1 and/or even on f2 and f3. With LBT, all cells must have a possibility to access the channel in a fair manner, so approximately with two competing cells the access probability is ½, with 3 cells is ⅓, with 4 cells is ¼, etc. So, the competition level is higher when more cells are competing for the channel in the same area on the same carrier. The parameter may be cell-specific or carrier specific related to channel availability. An example parameter may be a scaling factor which increases the measurement time period when accessing the channel is difficult or the probability of accessing the channel is below a threshold. The parameter may be determined by the UE 20 or may be signaled by the network. The parameter may also have some relation to LBT success rate or probability or LBT failure rate or probability.

NOTE: the same principle may apply even for intra-frequency measurement time period, which is because the cells measured by the same UE 20 are likely not able to transmit simultaneously and will have to compete for the channel so the UE 20 may not be able to measure multiple cells in parallel even on the same carrier frequency if that carrier frequency is subject to LBT. Thus if the UE 20 is required to measure eight intra-frequency cells, the measurement time may take, e.g., eight times longer on the carrier subject to LBT if only one at a time can transmit the signals measured by the UE 20. NOTE: in the above, the term “function” may refer to a mathematical function, logical function, statistical function, a rule for obtaining or deriving the result (e.g., T1), a mapping from one parameter value to another parameter value, etc.

In addition to the above, the measurement time period T1 may also depend on one or more of the below:

The measurement time period needed to perform the measurement without LBT (e.g., 6*Max{T_DMTC_periodicity,MGRP}*N_freq),

Bandwidth (e.g., measurement bandwidth),

Conditions (e.g., signal strength, signal quality, RSRP, RSRQ, SINR, RS-SINR, Es/Iot, Noc, Io),

Total number of carriers configured for UE operation,

Total number of inter-frequency carriers configured for UE operation,

At least one configuration parameter of transmissions used for the measurement by the UE 20 (e.g., periodicity such as DRS periodicity, DRS Measurement Timing Configuration (DMTC) periodicity, PRS periodicity, reference signal periodicity, System Information (SI) periodicity; transmission occasion length (e.g., number of symbols, subframes, etc.), etc.),

Measurement gap configuration (e.g., measurement gap type, measurement gap periodicity such as Measurement Gap Repetition Period (MGRP) of 40 ms or 80 ms, measurement gap length),

UE 20 activity configuration (e.g., Discontinuous Reception (DRX) cycle length)

Some more specific examples of inter-frequency T1:

T1=(M1*N_{freq}+L_{interAll})*Max{T_{DMTC}_{_{periodicity}}, MGRP}

T1=(M1+L1)*Max {T_{DMTC}_{_{periodicity}},MGRP}*M_{freq}

T1=(M1+L1)*Max {T_{DMTC}_{_{periodicity}},MGRP,DRXcycleLength}*N_{req} when DRX is configured

T1=(Σᵢ₌₁^{N}^{_{freq}}Mᵢ+Σᵢ₌₁^{N}Lᵢ)* Max {T_{DMTC}_{_{periodicity}},MGRP},

where Nfreq is the total number of carriers configured in the UE 20 and N is the number of carriers subject to LBT

T1=(M1*N_{freq}+L1*N)*Max {T_{DMTC}_{_{periodicity}},MGRP}

T1=(M1*N_{freq}+L1*N)* Max {T_{DMTC}_{_{periodicity}},MGRP, DRXcycleLength} when DRX is configured

T1=(M1*N_{freq}+Σᵢ₌₁^{N}Lᵢ)*Max {T_{DMTC}_{_{periodicity}},MGRP}

T1=(M1*N_{freq}+Σᵢ₌₁^{N}Lᵢ)*Max {T_{DMTC}_{_{periodicity}},MGRP,DRXcycleLength} when DRX is configured

T1=(Max_{i=1 . . . ,Nfreq}{Mᵢ}+Max_{k=1 . . . N}{Lₖ})* Max {T_{DMTC}_{_{periodicity}},MGRP}*N_{freq}

T1=(N_{freq}*Max_{i=1 . . . Nfreq}{Mᵢ}+N* Max_{k=1 . . . N}{Lₖ})* Max {T_{DMTC}_{_{periodicity}},MGRP}

T1=(M1*n* N_{freq})* Max {T_{DMTC}_{_{periodicity}},MGRP},

e.g., when multiple n cells on f1 are measured or n is the number of measured cells that are competing for the channel or n is the maximum per-carrier number of competing measured cells among the measured carriers (in one example, n=4 if f1 is inter-frequency and n=8 if f1 is intra-frequency) or n is a parameter reflecting the competition level for the channel to transmit in the occasions measured by the UE 20.

The determined measurement time period T1 may further apply under certain conditions, e.g., when one or more applies:

At least one parameter related to LBT is below a first threshold and/or above a second threshold, e.g., any one or more of:

L1 <L1max,

Li <Limax,

L_{interAll}<L_{interAll}-max,

max(Li) <Lmax,

Li <=Mi,

f(Li,Mi) <=threshold, e.g., Li/(Li+Mi) <=0.5 or in words Li does not exceed Mi or Li does not exceed 50% of Li+Mi which is the total number of configured occasions

the largest gap over T1 between any two consecutive discovery signal occasions which are available in the UE 20 (i.e., based on channel assessment) does not exceed a threshold (e.g., a fixed number or a function of at least one of T_DMTC_periodicity, MGRP, and DRX_cycle_length, such as k*(maximum T_DMTC_periodicity), where in one example k=5)

the gap between any two consecutive discovery signal occasions which are available in the UE 20 during T1 (i.e., based on channel assessment) does not exceed a threshold, i.e., based on channel assessment) does not exceed a threshold (e.g., a fixed number or a function of at least one of T_DMTC_periodicity, MGRP, and DRX_cycle_length, such as k*(maximum T_DMTC_periodicity), where in one example k=5

Determining T1 in a DAS or a Shared Cell Deployment: In a DAS deployment, in its broad sense (see discussion of DAS above), measurements may involve measurements on TP specific signals and on cell specific signals, e.g.,

T1=T1_CRS+T1_CSIRS, where T1_CRS may be determined similar to T1 described above but only with respect to CRS signals (for carriers in unlicensed spectrum, CRS are transmitted in periodic discovery signal occasions) and T1_CSIRS may be determined similar to T1 described above but only with respect to CSI-RS signals. Furthermore, T1=T1_CRS+T1_CSIRS may apply under additional conditions on LBT within a cell, e.g.:

During Tidentify_inter_TP_FS3 over multiple discovery signal occasions, the UE 20 may assume the following:

in the discovery signal occasions, which are available at the UE 20, the corresponding necessary cell-specific discovery signals are always available from the same set of RRHs in the measured cell, and

in the discovery signal occasions, which are not available at the UE 20, the corresponding necessary cell-specific discovery signals are not available from any RRH within the same measured cell.

Step 104: In this step, the UE 20 may control sharing the measurement gaps between the measurements on f1 and measurements on at least one of the other inter-frequency carrier frequencies f2 and/or f3, where f2 is not subject to LBT and f3 is subject to LBT.

The controlling may further comprise, e.g., one or more of:

Determining the measurement gap occasions to be used for the measurements on f1, while accounting for LBT on f1 and/or f3,

Determining the carrier(s) to be measured in the next measurement gap occasion, while accounting for LBT on f1 and/or f3,

Determining whether one or more carriers are to be measured within the same measurement gap (e.g., in a sequential order),

Some more specific examples:

using measurement gaps more frequently for measurements on f1 than on f2 to compensate for the impact of LBT on f1,

utilization of measurement gaps for f1 is a function of LBT on f1 (e.g., more gaps or more frequent gaps may be used for f1 when the success rate of LBT is low or below a threshold or the same usage as for f2 when the success rate of LBT is high or above a threshold or more gaps may be used for f1 than for f3 if accessing the channel is more difficult on f1)

utilization of measurement gaps for f1 is a function of the number of measured cells on f1 which may in turn determine the number of transmitting cells and the LBT success or failure rate since all these cells may not be able to transmit at the same time

if the cells to be measured during a measurement gap do not transmit due to LBT, the UE 20 may switch to another carrier already within this gap (DRS occasions arel ms long while the measurement gap is 6 ms, though additional interruptions should be considered when switching carriers which will reduce the effective time of a measurement gap, i.e., it may be not possible to measure DRS subframes on six carriers in one gap, but measuring on two carriers may be feasible)

Step 106: In this step, the UE 20 may perform the at least one first inter-frequency measurement, based on the determined measurement time period T1.

There may also be a timer in the UE 20 associated with the measurement time period T1.

Step 108: In this step, the UE 20 may determine a measurement time period T2 for performing at least one second inter-frequency measurement on a carrier frequency f2 which is not subject to LBT but which shares the measurement gaps with carrier frequency f1.

Similar rules as described for step 102 and step 104, but now for f2 not subject to LBT may apply.

For example, T2 may be a function of LBT on f1 and/or f3 which are subject to LBT. T2 may also be a function of the per-carrier number of cells competing for the channel or a parameter reflecting the competition level for the channel on f2 and/or f1 and f3.

Step 110: In this step, the UE 20 may perform the at least one second inter-frequency measurement based on the determined measurement time period T2.

Step 112: In this step, the UE 20 may send the at least one first inter-frequency measurement to another node (e.g., a network node) and/or using it for one or more operational tasks.

Some examples of operational tasks: mobility, positioning, RRM, SON, MDT, power control, link adaptation, load balancing, etc.

Step 114: In this step, the UE 20 may send the at least one second inter-frequency measurement to another node (e.g., a network node) and/or using it for one or more operational tasks.

Similar examples of operational tasks as in step 112.

As illustrated in FIG. 4, methods in a network node (e.g., a radio access node such as a base station (e.g., the macro node 12) or a core network node) for controlling UE inter-frequency measurements on a carrier frequency f1 comprise the steps of:

Step 200: Determining the need for measurement gaps for a UE 20 and configuring measurement gaps for a UE 20 to perform at least one first inter-frequency measurement on a carrier frequency f1 subject to LBT

Step 202: Determining a measurement time period T1 for performing the at least one first inter-frequency measurement in the measurement gaps

Step 204: Configuring in the UE 20 inter-frequency measurements at least on f1 based on the determined measurement time period T1

Step 206 (optional): Controlling (e.g., by means of measurement configuration and/or transmission configuration and/or cell list) sharing the measurement gaps between the measurements on f1 and measurements on at least one of the other inter-frequency carrier frequencies f2 and/or f3, where f2 is not subject to LBT and f3 is subject to LBT

Step 208 (optional): Receiving a measurement report based on the determined measurement time period T1

Step 210 (optional): Determining a measurement time period T2 for performing at least one second inter-frequency measurement on a carrier frequency f2 which is not subject to LBT but which shares the measurement gaps with carrier frequency f1

Step 212 (optional): Configuring the UE 20 inter-frequency measurements on f2 based on the determined measurement time period T2

Step 214 (optional): Receiving a measurement report, based on the determined measurement time period T2

Step 216 (optional): Using the at least one received inter-frequency measurement for one or more network node operational tasks or sending to another node (e.g., another network node)

See the discussion in the “Method in a UE” section above for an example scenario description.

Step 200: The need for measurement gaps may be determined, e.g., based on UE capability to perform inter-frequency measurement with or without measurement gaps.

Steps 202 and 210: Methods for determining the measurement time periods T1 and T2 may be similar to those described for the UE 20.

Steps 204 and 212: The UE 20 may be configured with inter-frequency measurements, e.g., via RRC or LTE Positioning Protocol (LPP) protocols.

The configuration will comprise at least the measurement type and carrier frequency.

Configuring a measurement in the UE 20 may also comprise operating a counter or a timer related to the determined measurement time period (e.g., starting the time when the measurement is configured or expected to start and stopping when the measurement is expected to stop at latest or upon receiving a measurement report).

Step 206: Principles for controlling the gap sharing may be similar to those described for the UE 20.

The controlling may be by means of gap (re)configuration, carrier reconfiguration, measurement reconfiguration, adaptive transmission control, adaptive LBT control, etc.

Steps 208 and 214: The UE 20 may receive a measurement report, e.g., via RRC.

Step 216: Some examples of operational tasks: mobility control, positioning, RRM, SON, MDT, power control, link adaptation, load balancing, etc.

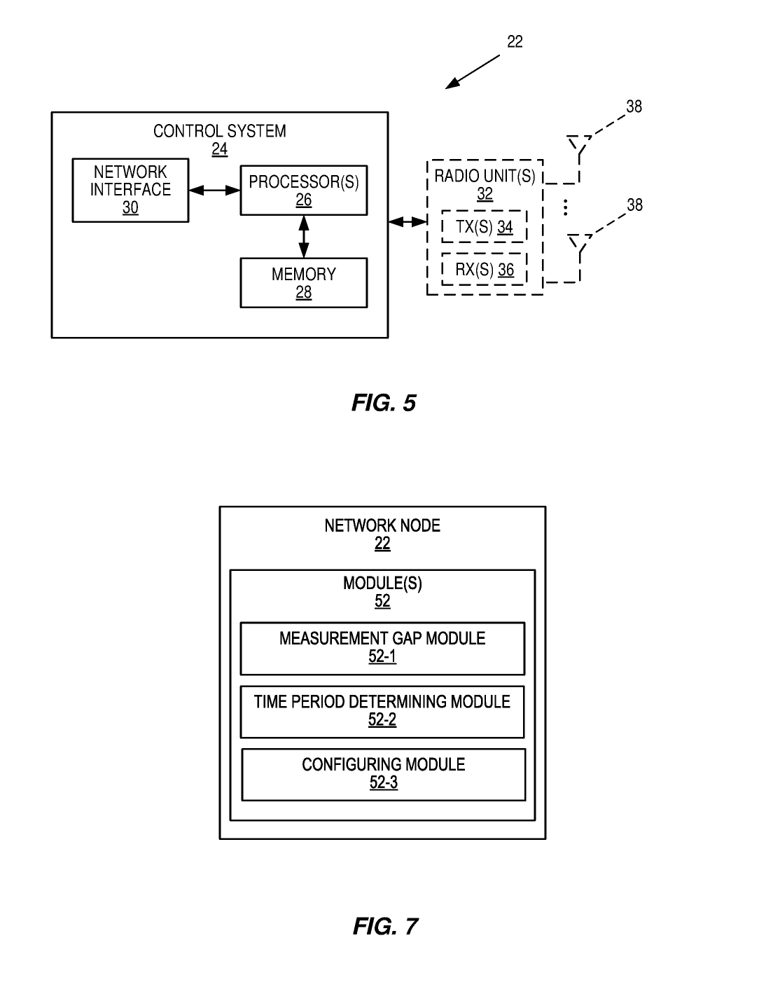

FIG. 5 is a schematic block diagram of a network node 22 according to some embodiments of the present disclosure. The network node 22 may be, for example, a radio access node such as, for example, a base station (e.g., the macro node 12 of FIG. 2) or a core network node. As illustrated, the network node 22 includes a control system 24 that includes one or more processors 26 (e.g., Central Processing Units (CPUs), Application Specific Integrated Circuits (ASICs), Field Programmable Gate Arrays (FPGAs), and/or the like), memory 28, and a network interface 30. In addition, if the network node 22 is a radio access node, then the network node 22 also includes one or more radio units 32 that each includes one or more transmitters 34 and one or more receivers 36 coupled to one or more antennas 38. In some embodiments, the radio unit(s) 32 is external to the control system 24 and connected to the control system 24 via, e.g., a wired connection (e.g., an optical cable). However, in some other embodiments, the radio unit(s) 32 and potentially the antenna(s) 42 are integrated together with the control system 24. The one or more processors 26 operate to provide one or more functions of a network node as described herein. In some embodiments, the function(s) are implemented in software that is stored, e.g., in the memory 28 and executed by the one or more processors 26.

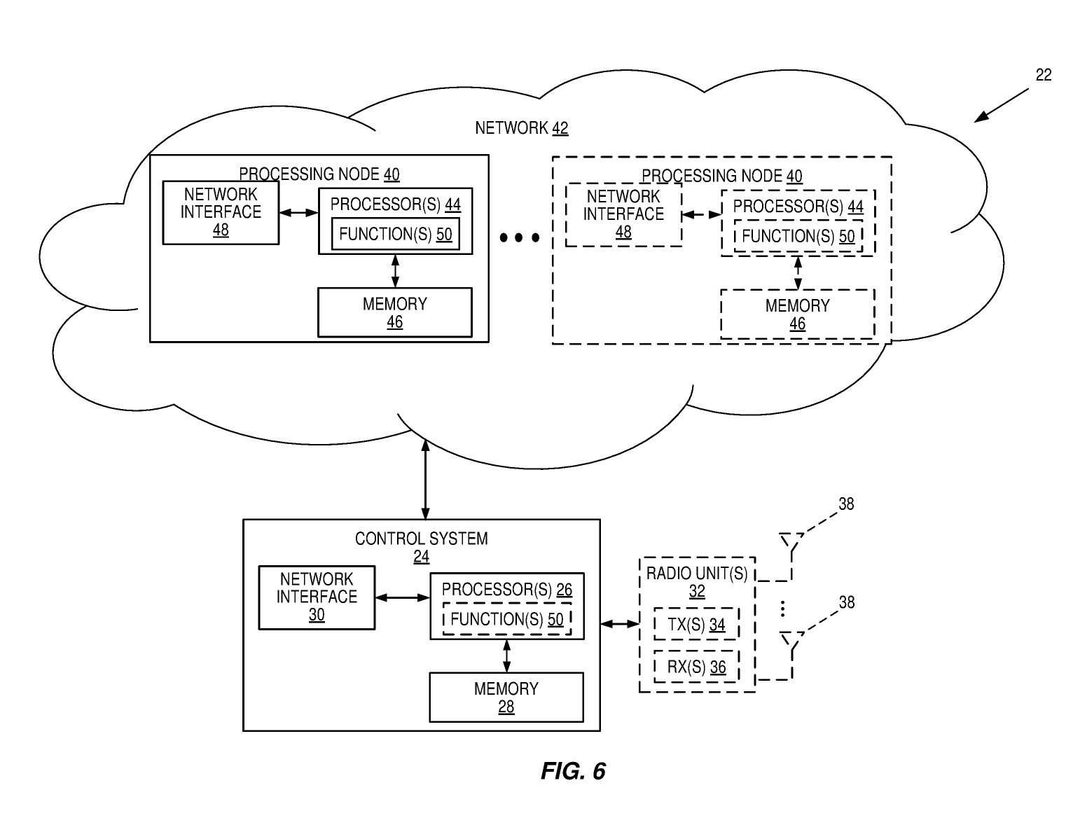

FIG. 6 is a schematic block diagram that illustrates a virtualized embodiment of the network node 22 according to some embodiments of the present disclosure. This discussion is equally applicable to other types of network nodes. Further, other types of network nodes may have similar virtualized architectures.

As used herein, a “virtualized” network node (e.g., a virtualized base station or a virtualized radio access node) is an implementation of the network node 22 in which at least a portion of the functionality of the network is implemented as a virtual component (e.g., via a virtual machine(s) executing on a physical processing node(s) in a network(s)). As illustrated, in this example, the network node 22 includes the control system 24 that includes the one or more processors 26 (e.g., CPUs, ASICs, FPGAs, and/or the like), the memory 28, and the network interface 30 and, depending on the type of network node, the one or more radio units 32 that each includes the one or more transmitters 34 and the one or more receivers 36 coupled to the one or more antennas 38, as described above. The control system 24 is connected to the radio unit(s) 32 via, for example, an optical cable or the like. The control system 24 is connected to one or more processing nodes 40 coupled to or included as part of a network(s) 42 via the network interface 30. Each processing node 40 includes one or more processors 44 (e.g., CPUs, ASICs, FPGAs, and/or the like), memory 46, and a network interface 48.

In this example, functions 50 of the network node (e.g., functions of the network node described above with respect to FIG. 4) described herein are implemented at the one or more processing nodes 40 or distributed across the control system 24 and the one or more processing nodes 40 in any desired manner. In some particular embodiments, some or all of the functions 50 of the network node 22 described herein are implemented as virtual components executed by one or more virtual machines implemented in a virtual environment(s) hosted by the processing node(s) 40. As will be appreciated by one of ordinary skill in the art, additional signaling or communication between the processing node(s) 40 and the control system 24 is used in order to carry out at least some of the desired functions 50. Notably, in some embodiments, the control system 24 may not be included, in which case the radio unit(s) 32 (if present in the particular embodiment—e.g., for radio access nodes) communicate directly with the processing node(s) 40 via an appropriate network interface(s). Further, in embodiments in which the network node 22 is not a radio access node (e.g., a core network node), then the network node 22 may be entirely virtualized (i.e., there may be no control system 24 or radio unit(s) 32.

In some embodiments, a computer program including instructions which, when executed by at least one processor, causes the at least one processor to carry out the functionality of a network node or a node (e.g., a processing node 40) implementing one or more of the functions 50 of the network node 22 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 7 is a schematic block diagram of the network node 22 according to some other embodiments of the present disclosure. This discussion is equally applicable to the processing node 40 of FIG. 6 where the modules 52 may be implemented at one of the processing nodes 40 or distributed across multiple processing nodes 40 and/or distributed across the processing node(s) 40 and the control system 24. The network node 22 includes one or more modules 52, each of which is implemented in software. The module(s) 52 provide the functionality of the network node 22 described herein. For example, the module(s) 52 may include one or modules that perform the operations of the network node 22 described with respect to FIG. 4 above (e.g., a measurement gap module 52-1 that performs step 200, a time period determining module 52-2 that performs step 202, and a configuring module 52-3 that performs step 204, etc.).

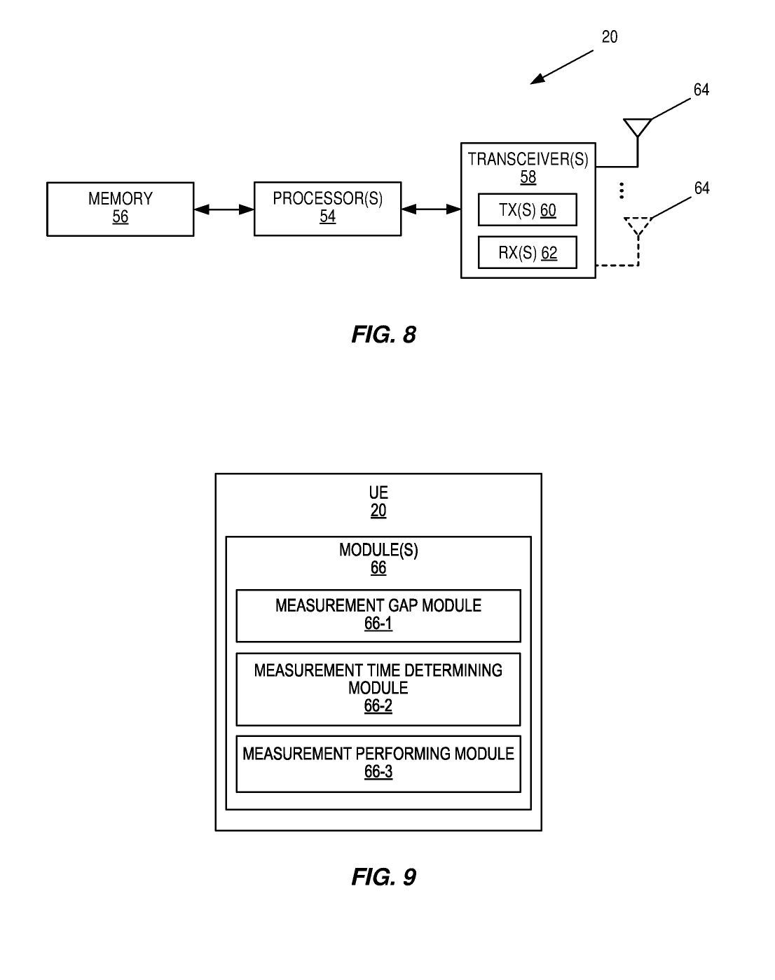

FIG. 8 is a schematic block diagram of the UE 20 according to some embodiments of the present disclosure. As illustrated, the UE 20 includes one or more processors 54 (e.g., CPUs, ASICs, FPGAs, and/or the like), memory 56, and one or more transceivers 58 each including one or more transmitters 60 and one or more receivers 62 coupled to one or more antennas 64. In some embodiments, the functionality of the UE 20 described above (e.g., with respect to FIG. 3) may be fully or partially implemented in software that is, e.g., stored in the memory 56 and executed by the processor(s) 54.

In some embodiments, a computer program including instructions which, when executed by at least one processor, causes the at least one processor to carry out the functionality of the UE 20 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 9 is a schematic block diagram of the UE 20 according to some other embodiments of the present disclosure. The UE 20 includes one or more modules 66, each of which is implemented in software. As an example, in some embodiments, the one or more modules 66 include one or more modules that operate to perform the process described above with respect to FIG. 3. For example, the modules 66 may include a measurement gap module 66-1 that operates to perform step 100 of FIG. 3, a measurement time determining module 66-2 that operates to perform step 102 of FIG. 3, a measurement performing module 66-3 that operates to perform step 106 of FIG. 3, etc.

While not being limited thereto, some example embodiments of the present disclosure are provided below.

A first embodiment is a method of operation of a UE, comprising: configuring measurement gaps for performing at least one first inter-frequency measurement on a first carrier frequency subject to LBT; determining a measurement time period T1 for performing the at least one first inter-frequency measurement in the measurement gaps; and performing the at least one first inter-frequency measurement based on the measurement time period T1.

A second embodiment is the method of the first embodiment further comprising controlling sharing of the measurement gaps between the at least one first inter-frequency measurements on the first carrier frequency and at least one other inter-frequency measurement on at least one other carrier.

A third embodiment is the method of the second embodiment wherein the at least one other carrier comprises at least one other carrier subject to LBT.

A fourth embodiment is the method of the second or third embodiment wherein the at least one other carrier comprises at least one other carrier not subject to LBT.

A fifth embodiment is the method of any one of the first, second, third, or fourth embodiment further comprising determining a measurement time period T2 for performing at least one second inter-frequency measurement on a second carrier frequency that is not subject to LBT but shares the measurement gaps with the first carrier frequency.

A sixth embodiment is the method of the fifth embodiment further comprising performing the at least one second inter-frequency measurement based on the measurement time period T2.

A seventh embodiment is the method of the fifth or sixth embodiment further comprising sending the at least one second inter-frequency measurement to another node.

An eighth embodiment is the method of any one of the fifth, sixth, or seventh embodiment further comprising using the at least one second inter-frequency measurement for one or more operational tasks.

A ninth embodiment is the method of any one of the previous embodiments further comprising sending the at least one first inter-frequency measurement to another node.

A tenth embodiment is the method of any one of the previous embodiments further comprising using the at least one first inter-frequency measurement for one or more operational tasks.

An eleventh embodiment is a UE adapted to configure measurement gaps for performing at least one first inter-frequency measurement on a first carrier frequency subject to LBT, determine a measurement time period T1 for performing the at least one first inter-frequency measurement in the measurement gaps, and perform the at least one first inter-frequency measurement based on the measurement time period T1.

A twelfth embodiment is the UE of the eleventh embodiment wherein the UE is further adapted to perform the method of any one of the first through tenth embodiments.

A thirteenth embodiment is a UE comprising at least one transceiver, at least one processor, and memory storing instructions executable by the at least one processor whereby the UE is operable to configure measurement gaps for performing at least one first inter-frequency measurement on a first carrier frequency subject to LBT, determine a measurement time period T1 for performing the at least one first inter-frequency measurement in the measurement gaps, and perform the at least one first inter-frequency measurement based on the measurement time period T1.

A fourteenth embodiment is a UE comprising a measurement gap module operable to configure measurement gaps for performing at least one first inter-frequency measurement on a first carrier frequency subject to LBT, a measurement time determining module operable to determine a measurement time period T1 for performing the at least one first inter-frequency measurement in the measurement gaps, and a measurement performing module operable to perform the at least one first inter-frequency measurement based on the measurement time period T1.

A fifteenth embodiment is a method of operation of a node comprising configuring measurement gaps for the UE to perform at least one first inter-frequency measurement on a first carrier subject to LBT, determining a measurement time period T1 for performing the at least one first inter-frequency measurement in the measurement gaps, and configuring in the UE the at least one first inter-frequency measurement on the first carrier based on the measurement time period T1.

A sixteenth embodiment is the method of the fifteenth embodiment further comprising controlling sharing of the measurement gaps at the UE between the at least one first inter-frequency measurement on the first carrier frequency and at least one other inter-frequency measurement on at least one other carrier.

A seventeenth embodiment is the method of the sixteenth embodiment wherein the at least one other carrier comprises at least one other carrier subject to LBT.

An eighteenth embodiment is the method of the sixteenth or seventeenth embodiment wherein the at least one other carrier comprise at least one other carrier not subject to LBT.

A nineteenth embodiment is the method of any one of the fifteenth through eighteenth embodiments further comprising receiving a measurement report from the UE based on the measurement time period T1.

A twentieth embodiment is the method of any one of the fifteenth through nineteenth embodiments further comprising determining a measurement time period T2 for performing at least one second inter-frequency measurement on a second carrier frequency that is not subject to LBT but shares the measurement gaps with the first carrier frequency.

A twenty-first embodiment is the method of the twentieth embodiment further comprising configuring in the UE the at least one second inter-frequency measurement on the second carrier based on the measurement time period T2.

A twenty-second embodiment is the method of the twenty-first embodiment further comprising receiving a measurement report from the UE based on the measurement time period T2.

A twenty-third embodiment is the method of any one of the fifteenth through twenty-second embodiments further comprising sending the at least one first inter-frequency measurement and/or the at least one second inter-frequency measurement contained in the respective measurement report to another node.

A twenty-fourth embodiment is the method of any one of the fifteenth through twenty-third embodiments further comprising using the at least one first inter-frequency measurement and/or the at least one second inter-frequency measurement contained in the respective measurement report for one or more operational tasks.

A twenty-fifth embodiment is a node adapted to configure measurement gaps for a UE to perform at least one first inter-frequency measurement on a first carrier subject to LBT, determine a measurement time period T1 for performing the at least one first inter-frequency measurement in the measurement gaps, and configure in the UE the at least one first inter-frequency measurement on the first carrier based on the measurement time period T1.

A twenty-sixth embodiment is the node of the twenty-fifth embodiment further adapted to perform the method of any of the sixteenth through twenty-fourth embodiments.

A twenty-seventh embodiment is a node comprising at least one processor and memory storing instructions executable by the at least one processor whereby the node is operable to configure measurement gaps for a UE to perform at least one first inter-frequency measurement on a first carrier subject to LBT, determine a measurement time period T1 for performing the at least one first inter-frequency measurement in the measurement gaps, and configure in the UE the at least one first inter-frequency measurement on the first carrier based on the measurement time period T1.

A twenty-eighth embodiment is a node comprising a measurement gap module operable to configure measurement gaps for a UE to perform at least one first inter-frequency measurement on a first carrier subject to LBT, a time period determining module operable to determine a measurement time period T1 for performing the at least one first inter-frequency measurement in the measurement gaps, and a configuring module operable to configure in the UE the at least one first inter-frequency measurement on the first carrier based on the measurement time period T1.

In some embodiments, aspects of the present disclosure can be incorporated into a Third Generation Partnership Project (3GPP) standard. In this regard, Appendix A includes example text for incorporation of at least some aspects of the present disclosure into 3GPP Technical Specification (TS) 36.133.

The following acronyms are used throughout this disclosure.

μps Microsecond

3GPP Third Generation Partnership Project

5G Fifth Generation

ACK Acknowledgement

ASIC Application Specific Integrated Circuit

CA Carrier Aggregation

CCA Clear Channel Assessment

CoMP Coordinated Multi-Point

CPE Customer Premises Equipment

CPU Central Processing Unit

CRS Common Reference Symbol/Cell Specific Reference Signal

CSI Channel State Information

CSI-RS Channel State Information Reference Signal

CSMA Carrier Sense Multiple Access

D2D Device to Device

DAS Distributed Antenna System

DC Dual Connectivity

DL Downlink

DMTC Discovery Reference Symbol Measurement Timing Configuration

DRS Discovery Reference Symbol

DRX Discontinuous Reception

eNB Enhanced or Evolved Node B

E-SMLC Evolved Serving Mobile Location Centre

E-UTRAN Evolved Universal Terrestrial Radio Access Network

FPGA Field Programmable Gate Array

FS3 Frame Structure Type 3

HARQ Hybrid Automatic Repeat Request

ID Identifier

LAA License Assisted Access

LBT Listen-Before-Talk

LEE Laptop Embedded Equipment

LME Laptop Mounted Equipment

LPP Long Term Evolution Positioning Protocol

LTE Long Term Evolution

M2M Machine to Machine

MBSFN Multicast Broadcast Single Frequency Network

MCE Multi-Cell/Multicast Coordination Entity

MDT Minimization of Drive Tests

MGRP Measurement Gap Repetition Period

MME Mobility Management Entity

ms Millisecond

NACK Negative Acknowledgement

NB-IoT Narrowband Internet of Things

NR New Radio

ms Nanosecond

PBCH Physical Broadcast Channel

PCC Primary Component Carrier

PCell Primary Cell

PCFICH Physical Control Format Indicator Channel

PCI Physical Cell Identifier

PDCCH Physical Downlink Control Channel

PDSCH Physical Downlink Shared Channel

PHICH Physical Hybrid Automatic Repeat Request Indicator Channel

PMI Precoding Matrix Indicator

PRS Positioning Reference Signal

PSCC Primary Secondary Component Carrier

PSS Primary Synchronization Signal

RAT Radio Access Technology

Rel Release

RLM Radio Link Monitoring

RRC Radio Resource Control

RRH Remote Radio Head

RRM Radio Resource Management

RRU Remote Radio Unit

RS Reference Signal

RSRP Reference Signal Received Power

RSRQ Reference Signal Received Quality

RSSI Received Signal Strength Indicator

RSTD Reference Signal Time Difference

RTT Round Trip Time

Rx Receive

SCC Secondary Component Carrier

SCell Secondary Cell

SFN System Frame Number

SI System Information

SIB System Information Block

SINR Signal to Interference plus Noise Ratio

SMLC Serving Mobile Location Centre

SON Self Organizing Node

SSS Secondary Synchronization Signal

TOA Time of Arrival

TP Transmission Point

TS Technical Specification

TTI Transmission Time Interval

Tx Transmit

UE User Equipment

UL Uplink

USB Universal Serial Bus

UTRA Universal Terrestrial Radio Access

Those skilled in the art will recognize improvements and modifications to the embodiments of the present disclosure. All such improvements and modifications are considered within the scope of the concepts disclosed herein.

1. A method of operation of a User Equipment, UE, comprising:
configuring measurement gaps for performing at least one first inter-frequency measurement on a first carrier frequency subject to Listen-Before-Talk, LBT;
determining a measurement time period T1 for performing the at least one first inter-frequency measurement in the measurement gaps; and
performing the at least one first inter-frequency measurement based on the measurement time period T1.

2. (canceled)

3. The method of claim 1 wherein determining the measurement time period T1 comprises determining the measurement time period T1 based on a predefined rule, a set of predefined values, a table of predefined values, a message received from another node, and/or at least one LBT-related configuration or LBT-related data.

4. The method of claim 1 wherein determining the measurement time period T1 comprises determining the measurement time period T1 such that the measurement time period T1 is a function of a number of transmission occasions which could be used for measurement by the UE but which are not available at the UE due to LBT on the first carrier frequency.

5. The method of claim 1 wherein determining the measurement time period T1 comprises determining the measurement time period T1 such that the measurement time period T1 is a function of a number of cells that are competing for a channel on the first carrier frequency to measure.

6. The method of claim 1 wherein determining the measurement time period T1 comprises determining the measurement time period T1 such that the measurement time period T1 is a function of a parameter reflecting a competition level for accessing a channel on the first carrier frequency and/or a channel of another carrier frequency.

7-16. (canceled)

17. The method of claim 1 wherein the measurement time period T1 is a function of a number of carriers sharing the measurement gaps.

18. The method of claim 1 wherein the measurement time period T1 is a function of a parameter that determines a basic measurement time period on the first carrier frequency without LBT failure.

19. The method of claim 1 wherein the measurement time period T1 is a function of a number of competing for the channel cells to measure on the first carrier frequency.

20. The method of claim 1 further comprising controlling sharing of the measurement gaps between the at least one first inter-frequency measurement on the first carrier frequency and at least one other inter-frequency measurement on at least one other carrier.

21. The method of claim 20 wherein the at least one other carrier comprises at least one other carrier subject to LBT.

22. The method of claim 20 wherein the at least one other carrier comprises at least one other carrier not subject to LBT.

23. The method of claim 19 further comprising determining a measurement time period T2 for performing at least one second inter-frequency measurement on a second carrier frequency that is not subject to LBT but shares the measurement gaps with the first carrier frequency.

24. The method of claim 23 further comprising performing the at least one second inter-frequency measurement based on the measurement time period T2.

25-30. (canceled)

31. A User Equipment, UE, comprising:
at least one transceiver;
at least one processor; and
memory storing instructions executable by the at least one processor whereby the UE is operable to:
configure measurement gaps for performing at least one first inter-frequency measurement on a first carrier frequency subject to Listen-Before-Talk, LBT;
determine a measurement time period T1 for performing the at least one first inter-frequency measurement in the measurement gaps; and
perform the at least one first inter-frequency measurement based on the measurement time period T1.

32-60. (canceled)

61. A node comprising:
at least one processor;
memory storing instructions executable by the at least one processor whereby the node is operable to:
configure measurement gaps for a User Equipment, UE, to perform at least one first inter-frequency measurement on a first carrier subject to Listen-Before-Talk, LBT;
determine a measurement time period T1 for performing the at least one first inter-frequency measurement in the measurement gaps; and
configure in the UE the at least one first inter-frequency measurement on the first carrier based on the measurement time period T1.

62. (canceled)

63. The method of claim 31 wherein determining the measurement time period T1 comprises determining the measurement time period T1 based on a predefined rule, a set of predefined values, a table of predefined values, a message received from another node, and/or at least one LBT-related configuration or LBT-related data.

64. The UE of claim 31 wherein determining the measurement time period T1 comprises determining the measurement time period T1 such that the measurement time period T1 is a function of a number of transmission occasions which could be used for measurement by the UE but which are not available at the UE due to LBT on the first carrier frequency.

65. The UE of claim 31 wherein determining the measurement time period T1 comprises determining the measurement time period T1 such that the measurement time period T1 is a function of a number of cells that are competing for a channel on the first carrier frequency to measure.

66. The UE of claim 31 wherein determining the measurement time period T1 comprises determining the measurement time period T1 such that the measurement time period T1 is a function of a parameter reflecting a competition level for accessing a channel on the first carrier frequency and/or a channel of another carrier frequency.

67. The UE of claim 66 wherein the parameter is cell-specific.

68. The UE of claim 66 wherein the parameter is carrier specific.

69. The UE of claim 66 wherein the parameter is a scaling factor which increases the measurement time period T1 when accessing the channel is difficult or a probability of accessing the channel is below a threshold.

70. The UE of claim 66 wherein the parameter is related to LBT success rate or probability or LBT failure rate or probability.

71. The UE of claim 66 wherein the parameter is determined by the UE.

72. The UE of claim 66 wherein the parameter is signaled to the UE from a network node.

73. The UE of claim 31 wherein determining the measurement time period T1 comprises determining the measurement time period T1 as
T1=(M1*N_{freq}+L1*N)* Max {T_{DMTC}_{_{periodicity}},MGRP} where:
M1 is a parameter determining a basic measurement time period on the first carrier frequency without LBT, even though f1 is subject to LBT,
N_{freq} is a total number of carrier frequencies configured in the UE,
L1 is a number of transmission occasions which could be used for UE measurements on the first carrier frequency but which are not available at the UE due to LBT,
N is a number of the total number of carrier frequencies configured in the UE that are subject to LBT,
T_{DMTC}_{_{periodicity}} is a discovery signal measurement timing configuration periodicity of higher layer, N_{freq}, and
MGRP is a measurement gap repetition period.

74. The UE of claim 31 wherein determining the measurement time period T1 comprises determining the measurement time period T1 as T1=(M1*N_{freq}+L1*N)*Max {T_{DMTC}_{_{periodicity}},MGRP,DRXcycleLength} where:
M1 is a parameter determining a basic measurement time period on the first carrier frequency without LBT, even though f1 is subject to LBT,
N_{freq} is a total number of carrier frequencies configured in the UE,
L1 is a number of transmission occasions which could be used for UE measurements on the first carrier frequency but which are not available at the UE due to LBT,
N is a number of the total number of carrier frequencies configured in the UE that are subject to LBT,
T_{DMTC}_{_{periodicity}} is a discovery signal measurement timing configuration periodicity of higher layer, N_{freq},
MGRP is a measurement gap repetition period, and
DRXcycleLength is a Discontinuous Reception, DRX, cycle length when DRX is configured for the UE.

75. The UE of claim 31 wherein determining the measurement time period T1 comprises determining the measurement time period T1 as
T1=(M1*n*N_{freq})*Max {T_{DMTC}_{_{periodicity}},MGRP} where:
M1 is a parameter determining a basic measurement time period on the first carrier frequency without LBT, even though f1 is subject to LBT,
n is a number of cells on the first carrier frequency that are measured, the number of cells on the first carrier frequency that are measured and are competing for the channel, a maximum per-carrier number of competing measured cells among a number of measured carrier frequencies, or a parameter reflecting a competition level for a channel on the first carrier frequency to transmit in transmission occasions measured by the UE,
N_{freq} is a total number of carrier frequencies configured in the UE,
T_{DMTC}_{_{periodicity}} is a discovery signal measurement timing configuration periodicity of higher layer, N_{freq}, and
MGRP is a measurement gap repetition period.

76. The UE of claim 31 wherein the measurement time period T1 is a function of a number of carriers subject to LBT for which the UE is configured to perform measurements.
